(19) United States
(12) Patent Application Publication
(10) Pub. No.: US 2005/0163221 A1
(43) Pub. Date: Jul. 28, 2005

(54) Motion vector detecting device

(75) Inventors: Hidemi Oka, Hyogo (JP); Shouzou Fujii, Osaka (JP); Shinjirou Mizuno, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/033,626

(22) Filed: Jan. 13, 2005

(30) Foreign Application Priority Data
Jan. 14, 2004 (JP) P2004-6290

(51) Int. Cl. H04N 7/12

(52) U.S. Cl. 375/240.16; 375/240.24

(57) ABSTRACT

A motion vector detecting device according to the present invention, wherein original image data constituting a video unit of digital video data is divided into a plurality of processing blocks and the respective processing blocks are subjected to a block-matching process relative to reference image data temporally close to the original image data so that motion vectors of the processing blocks are detected, is constituted as follows. The motion vector detecting device according to the present invention comprises a general vector detecting unit for detecting a general vector serving as a shift amount of the original image data, a search region determining unit for designating a region on the original image data including the processing block to be block-matched and biasing area-wise in a direction indicated by the general vector as a search region of the motion vector, and a vector detecting unit for executing the block-matching process to the search region and thereby detecting the motion vector of the processing block to be processed. The foregoing constitution enables the reduction of power consumption and a flexible response to any rapid change of a video.

### FIELD OF THE INVENTION

The present invention relates to a motion vector detecting device for detecting a motion vector by block-matching a plurality of processing blocks into which original image data constituting a video unit of video data is divided into to reference image data.

### DESCRIPTION OF THE RELATED ART

As an example of a method of encoding and recording or transmitting a video signal, methods of utilizing time correlation between images temporally close to each other are available, one of which is a MPEG-2 encoding method. In the MPEG-2 encoding method, original image data as a target is divided into blocks of a predetermined size, and the blocks are block-matched to a predetermined search region of reference image data, in response to which a motion vector is detected and a predictive error is encoded so that an encoding efficiency is increased. It is necessary to extend the search region and thereby detect the block having a less error amount in order to increase a prediction accuracy. However, an enormous operation quantity is required for searching the motion vector in a broad region involving such problems that a circuit size is increased power consumption is also increased.

In order to solve the foregoing problems, a technology for improving a detection accuracy of the motion vector while decreasing the operation quantity by limiting the search region has been proposed (for example, see Page 2-3 and FIG. 1 of No. H10-336666 of the Publication of the Unexamined Japanese Patent Applications).

FIG. 16 shows a block diagram of a conventional motion vector detecting device. The reference image data is stored in a reference image memory 1201. The original image data currently targeted for the detection of the motion vector is stored in an original image memory 1202. A vector detecting unit 1203 implements the block-matching between the original image data and the reference image data to thereby detect the motion vector of each processing block on the original image data. A vector statistical processing unit 1204 calculates an average value and a histogram of the detected motion vector per screen. A moving amount designating unit 1205 calculates a moving amount of the search region from the calculated average value and histogram. A search region determining unit 1206 determines a region to be targeted for the search of the motion vector to be searched in accordance with the moving amount.

In the conventional motion vector detecting device, as described, the moving amount is calculated based on the statistical amount of the motion vector detected in the past encoding process and a position of the region where the motion vector is detected is moved based on the moving amount so that an image quality can be improved without changing the limited size of the search region.

According to the foregoing constitution, however, it is not possible to deal with any rapid change occurred in the video because the information of the motion vector detected in the past. As a further problem included in the conventional method, there is no indicator for restricting the size of the search region, which only allows the motion vector to be detected in the search region constantly having a fixed size. Accordingly, the operation executed, for example, in processing a video approximate to a still image in which no change is detected unfavorably results in the same processing volume. As a result, the extra power consumption is generated by the execution of an unnecessary process. It would be an option to restrict the size of the search region by using information of the motion vector detected in the past such as a variability and the like of the vector, which is, however, still inadequate for properly responding to the rapid change of the video.

### SUMMARY OF THE INVENTION

Therefore, a main object of the present invention is to provide a motion vector detecting device capable of responding to the rapid change of the video.

Another object of the present invention is to provide a motion vector detecting device capable of lowering the power consumption.

In order to solve the foregoing problems, a motion vector detecting device according to the present invention, wherein original image data constituting a video unit of digital video data is divided into a plurality of processing blocks and the respective processing blocks are subjected to a block-matching process relative to reference image data temporally close to the original image data so that the motion vectors of the processing blocks are detected, is constituted as follows. The video unit of the video data refers to frame data or field data. “To be temporally close” means that a time length corresponding to five frames or less or preferably to three frames or less in terms of frame time.

The motion vector detecting device according to the present invention comprises a general vector detecting unit for detecting a general vector serving as a shift amount of the original image data relative to the reference image data on an entire screen and calculating a correlativity in disposing the reference image data and the original image data being shifted relative to each other by the shift amount when the general vector is determined, a search region determining unit for specifying a size and a position of the search region of the motion vector based on the general vector and the correlativity, and a vector detecting unit for executing the block-matching process to the search region and thereby detecting the motion vectors of the respective processing blocks.

The general vector detecting unit obtains the general vector serving as the motion amount on the entire screen using, not the past information, but the image information relating to the original image data and the reference image data actually used for the vector detection, and further, calculates the correlativity between the images of the original image data and the reference image data using not past information but image information relating to the original image data and the reference image data actually used for the vector detection. The correlativity is an indicator for showing a similarity between the original image data and the reference image data. When the correlativity is high, it is denoted that the image includes only a small number of partial motions and approximate to the still image, or a state in which the image approximate to the still image is being panned is shown. On the contrary, when the correlativity is low, it is denoted that the image is undergoing the rapid change due to a large number of partial motions generated therein. Thus, when the correlativity is used as the indicator for showing a reliability of the general vector or judging whether or not the detected general vector is directly used as the moving amount of the search region, the search region can be correctly set. The search region determining unit uses, not the past information, but the general vector and the correlativity between the images actually used for the vector detection to thereby determine the position and size of the suitable search region. In other words, the search region is enlarged in the case of the image having the low correlativity and undergoing the rapid change due to many partial motions generated therein, while the search region is reduced in the case of the image having the high correlativity and approximate to the still image with a small number of partial motions generated therein. The search region determining unit, further, moves the search region whose size is determined based on the general vector to thereby determine the search region to which the vector detection is actually carried out. The motion vector is detected with an improved efficiency when the expanded region is designated as the search region with respect to the panned image having a high speed. In the foregoing manner, the processing quantity can be decreased and the power consumption can be controlled in the case of the image in which the motion is not really detected.

The search region determining unit preferably sets a first region including the processing block to be processed and designates a second region which is the first region disposed in the shifted manner as the search region of the motion vector, and further, restricts the amount of the position shift of the second region relative to the first region to a minimum level when the correlativity is high and the general vector is small.

Thereby, the processing quantity and the power consumption required for processing the image with less motion can be more precisely controlled. Further, when the correlativity is low or the general vector is large, the search region can be approximated to a predetermined maximum processing capacity, and an optimum search region can be thereby set making it possible to respond to any rapid change of the video.

The search region determining unit preferably restricts an extent by which the general vector is reflected on the shift amount when the correlativity is equal to or less than a predetermined threshold value. Then, when the correlativity is more reliable, the general vector can be directly used, while the general vector can be corrected so as to approximate to zero when the correlativity is less reliable. In such a manner, a periphery of the processing blocks can be evenly searched. More specifically, in moving the search region, the search region is shifted only when there is a certain motion, while the moving amount can be restricted in the opposite case. As a result, the search region can be less incorrectly set.

The general vector detecting unit preferably comprises an error amount detecting section for obtaining an error amount between pixels in a part where the original image data and the reference image data are overlapped with each other while the two data are being shifted relative to each other, an optimum position detecting section for detecting the general vector based on a direction indicating the position shift amount by which the error amount can be minimized and a correlativity calculating section for calculating a correlativity between the pixel data in the overlapping part. Thereby, the general vector and the correlativity can be more accurately obtained, enabling the operation quantity to be decreased.

In the foregoing constitution, the error amount detecting section and the correlativity calculating section preferably obtain the error amount and the correlativity between the data at a representative point at which the original image data is thinned and a representative point at which the reference image data is thinned. When the data is thinned at the representative point, the operation quantity at a time can be cut down, which leads the overall operation quantity to be further decreased.

In the foregoing constitution, the error amount detecting section and the correlativity calculating section according to a different mode average the pixels present in a region having a width wider than an interval between the adjacent representative points when the representative points are obtained by thinning the original image data and the reference image data.

In the foregoing constitution, the error amount detecting section and the correlativity calculating section may be adapted to set an interval of the pixels at which the original image data is thinned relative to an interval of the pixels at which the reference image data is thinned to N times (N is an integer) when the representative points are obtained by thinning the original image data and the reference image data and obtain the error amount and the correlativity only based on the data of the representative point at which the original image data is thinned. The foregoing constitution further decreases the operation quantity by thinning the data at the representative point and further advantageously controls the deterioration of an accuracy in the error amount operation.

A motion vector detecting device according to a modification example of the present invention may be constituted in such manner that the general vector is used but the correlativity is not used. More specifically, the motion vector detecting device comprises a general vector detecting unit for detecting the general vector serving as the shift amount of the original image data relative to the reference image data on the entire screen, a search region determining unit for designating a region on the original image data including the processing block to be block-matched and biasing area-wise in a direction indicated by the general vector as the search region of the motion vector and a vector detecting unit for executing the block-matching process to the search region and thereby detecting the motion vector of the processing block to be processed.

The general vector detecting unit uses, not the past information, but the image information relating to the original image data and the reference image actually used for the vector detection to thereby obtain the general vector as the motion amount on the entire screen. The search region determining unit uses, not the past information, but the general vector between the images actually used for the vector detection to thereby determine the position and size of the suitable search region. The search region determining unit moves the search region whose size is determined based on the general vector to thereby determine the search region for which the detection of the motion vector is actually carried out. The extended region is used as the search region with respect to the high-speed panned image so that the motion vector can be detected with an improved efficiency. Thereby, the operation quantity and the power consumption in the case of the image with less motion can be controlled.

The search region determining unit preferably sets the first region including the processing block to be processed and designates the second region which is the first position position-shifted in the direction indicated by the general vector as the search region of the motion vector.

The general vector detecting unit preferably restricts the amount of the position shift of the second region relative to the first region so as to be in a range of the second region in which the processing block is included. Then, the search region can be consecutive while being moved, which controls a reading amount of the memory. As a result, the power consumption can be further controlled.

The general vector detecting unit preferably comprises an error amount detecting section for obtaining the error amount between the pixels in the part where the original image data and a reference image data are overlapped with each other while the two data are being shifted relative to each other and the optimum position detecting section for detecting the general vector based on the amount of the position shift by which the error amount can be minimized. Thereby, the general vector of a high precision can be obtained, and further, the operation quantity can be advantageously decreased.

The error amount detecting section preferably obtains the error amount between the representative point at which the original image data is thinned and the representative point at which the reference image data is thinned. When the image data is thinned at the representative point, the operation quantity can be decreased.

The error amount detecting section preferably averages the pixels present in the region having the width wider than the interval between the adjacent representative points when the representative points are obtained by thinning the original image data and the reference image data. Then, the operation quantity can be further decreased.

The error amount detecting section sets the interval of the pixels at which the original image data is thinned relative to the interval of the pixels at which the reference image data is thinned to N times (N is an integer) and obtains the error amount only based on the data at the representative point at which the original image data is thinned when the representative points are obtained from the original image data and the reference image data. When the image data is thinned at the representative point, the operation quantity is further decreased, and the deterioration of the accuracy in the operation of the error amount can be controlled.

A motion vector detecting device according to a modification example of the present invention may be constituted in such manner that the correlativity is used, but the general vector is not used. More specifically, the motion vector detecting device comprises a correlativity calculating section for detecting the correlativity between the original image data and the reference image data, a search region determining unit for designating the search region of the motion vector including the processing block to be block-matched and narrowing the search region in the case of the high correlativity in comparison to the search region in the case of the low correlativity and a vector detecting unit for executing the block-matching to the search region and thereby detecting the motion vectors of the respective processing blocks.

The correlativity calculating section uses, not the past information, but the image information relating to the original image data and the reference image data actually used for the vector detection to thereby calculate the correlativity between the original image data and the reference image data. The correlativity is the indicator for showing the similarity between the original image data and the reference image data. When the correlativity is high, it is denoted that the image includes only a small number of partial motions and approximate to the still image, or a state in which the image approximate to the still image is panned is shown. On the contrary, when the correlativity is low, it is denoted that the image is undergoing the rapid change due to a large number of partial motions generated therein. The search region determining unit uses, not the past information, but the correlativity between the images actually used for the vector detection to thereby determine the position and the size of the suitable search region. In the case of the image whose correlativity is low and undergoing the rapid change with a large number of partial motions, the search region is enlarged. On the contrary, in the case of the image whose having a high correlativity and approximate to the still image with a small number of partial motions generated therein, the search region is reduced. The extended region is used as the search region with respect to the high-speed panned image so that the motion vector can be detected with an improved efficiency. Thus, the operation quantity and the power consumption for the image with less motion can be controlled.

In the foregoing constitution, the correlativity calculating section preferably obtains the correlativity between the representative point at which the original image data is thinned and the representative point at which the reference image data is thinned. The operation quantity can be decreased as a result of thinning the image data at the representative points.

Further, in the foregoing constitution, the correlativity calculating section may average the pixels present in the region having the width wider than the interval between the representative points when the representative points are obtained by thinning the original image data and the reference image data.

According to the present invention, the search region is determined based on, not the past detection information, but the image data actually used for the vector detection. Therefore, the search region of a suitable size can be provided at a suitable position, and motion vector can be detected while responding to the rapid change of the video achieving cutbacks of the circuit size, operation quantity and power consumption.

### BRIEF DESCRIPTION OF THE DRAWINGS

These and other objects as well as advantages of the invention will become clear by the following description of preferred embodiments and explicit in the appended claims of the invention. Many other benefits of the invention not mentioned in this specification will come to the attention of those skilled in the art upon implementing the present invention.

FIG. 1 is a block diagram of a motion vector detecting device according to an embodiment 1 of the present invention.

FIG. 2 is an illustration of a movement of a search region according to the embodiment 1.

FIG. 3 is an illustration of an example of a relationship between correlativity and reliability according to the embodiment 1.

FIG. 4 is a block diagram of an example of the motion vector detecting device used in the embodiment 1.

FIG. 5 is an illustration of a method of generating representative-point data according to the embodiment 1.

FIG. 6 is an illustration of thinning the representative-point data according to the embodiment 1.

FIG. 7 is an illustration of a method of detecting a general vector according to the embodiment 1.

FIG. 8 is a timing chart of a process of detecting a motion vector according to the embodiment 1.

FIG. 9 is a block diagram of a motion vector detecting device according to an embodiment 2 of the present invention.

FIG. 10 is a block diagram of an example of the motion vector detecting device used in the embodiment 2.

FIG. 11 is a timing chart of a process of detecting the motion vector according to the embodiment 2.

FIG. 12 is a block diagram of a first modification example of the present invention.

FIG. 13 is a block diagram of a second modification example of the present invention.

FIG. 14 is a block diagram of a third modification example of the present invention.

FIG. 15 is a block diagram of a fourth modification example of the present invention.

FIG. 16 is a block diagram of a conventional motion vector detecting device.

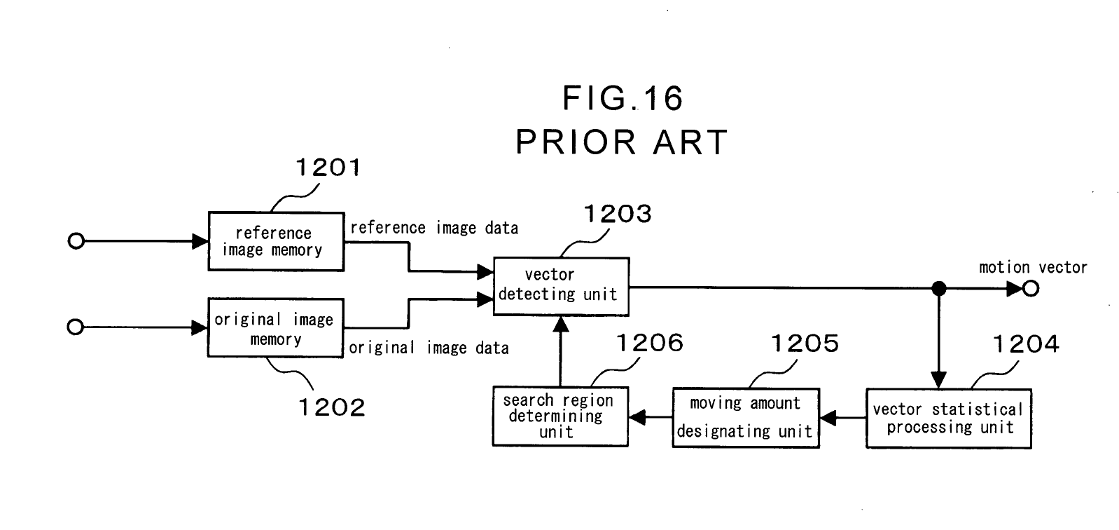

### DESCRIPTION OF THE PREFERRED EMBODIMENTS

In a motion vector detecting device according to the present invention, a general vector representing a motion amount on an entire screen and a correlativity between images are calculated by means of image information relating to original image data and reference image data actually used for the vector detection, and a size and a position of a search region are determined by means of the general vector and the correlativity so that an appropriate response can be made to any rapid change of the video and a prediction accuracy can be increased.

Hereinafter, preferred embodiments of the motion vector detecting device according to the present invention are described in detail referring to the drawings.

### Embodiment 1

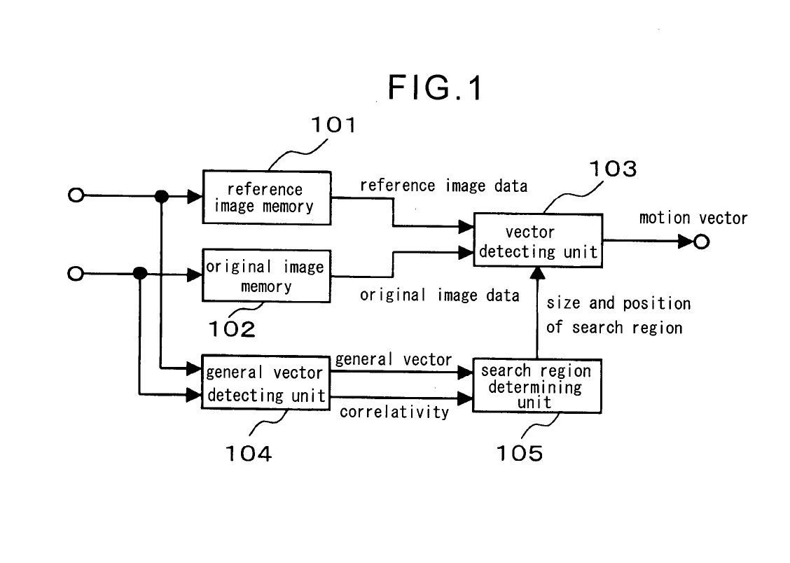

FIG. 1 is a block diagram of a motion vector detecting device according to an embodiment 1 of the present invention. Referring to reference numerals in the drawing, 101 denotes a reference image memory, 102 denotes an original image memory, 103 denotes a vector detecting unit, 104 denotes a general vector detecting unit and 105 denotes a search region determining unit.

The motion vector detecting device according to the present invention including the present embodiment detects a motion vector in the same manner as in the encoding method of MPEG-2 according to the conventional technology. More specifically, the original image data as a target is divided into blocks having a predetermined size and the respective blocks are block-matched to a predetermined search region of the reference image data so that the motion vector is detected. An encoding efficiency can be increased when a predictive error is encoded in the encoding method employing the motion vector. The foregoing image data constitute a video unit of video data. The video unit refers to frame data or field data. The reference image data refers to image data temporally close to the original image data. To describe “temporally close”, the image are temporally distant from each other by a length of time corresponding to five frames or below and preferably to three frames or below in terms of frame time.

The reference image data is stored in the reference image memory 101. The original image data targeted for the detection of the motion vector is stored in the original image memory 102. The vector detecting unit 103 block-matches the original image data to the reference image data for each predetermined processing block to thereby detect the motion vectors of the respective processing blocks. The general vector detecting unit 104 detects the general vectors of the reference image data and the original image data, and further, calculates the correlativity between the two images. The search region determining unit 105 determines the size and the position of the search region of the motion vector detected by the vector detecting unit 103 based on the general vector and the correlativity.

First, a method of determining the size of the search region in the motion vector detecting device according to the present embodiment is described. The correlativity is an indicator for showing a similarity between the two images. When the correlativity is high, it is denoted that the whole of the image is in a state which is approximate to a still image with a small number of partial motions generated therein, or the image approximate to the still image is being panned on the screen. On the contrary, when the correlativity is low, it is denoted that the image is undergoing a rapid change with a large number of partial motions generated therein.

The search region determining unit 105 determines that the search region is enlarged to an extent allowed by a processing capacity of the device when the correlativity is low, and the search region is reduced when the correlativity is high. Thereby, when the image with less motion is photographed, a processing quantity can be decreased and power consumption can be cut down.

As a specific method of determining the search region, for example, the correlativity is classified into different levels based on a plurality of threshold values, and the size of the search region is changed through different stages. It is possible to solely control the size of the search region using the correlativity, however, a size of the general vector can also be used as an indicator for determining the search region. For example, when a moving object is followed and photographed, a motion of the entire image is entrained by the background and therefore handled as a panned image. However, the image of the photographed object possibly involves a movement. Therefore, in the foregoing case, it is preferable to provide the search region to a certain extent in a periphery of the processing blocks. When the foregoing state is likely to occur, the size of the general vector is used as the indicator for determining the search region.

Based on the foregoing description, the motion vector detecting device according to the present embodiment is adapted to provide two-dimensional coordinates representing the correlativity and the general vector length and to restrict the search region only when the correlativity is high and the general vector is small. On the contrary, when the correlativity is low and the length of the general vector is large, the search region is approximated to a maximum processing capacity. Thus, the size of the search region is optionally determined in accordance with the correlativity and the general vector.

More specifically, the correlativity and the general vector are respectively classified into different levels based on a plurality of threshold values, as a result of which a table of a matrix shape is provided. Then, the before-mentioned constitution can be realized because the size of the search region can be changed through stages.

Next, a method of determining a position at which the search region is set is described. The search region determining unit 105 determines a new search region by moving the search region based on the general vector detected by the general vector detecting unit 104.

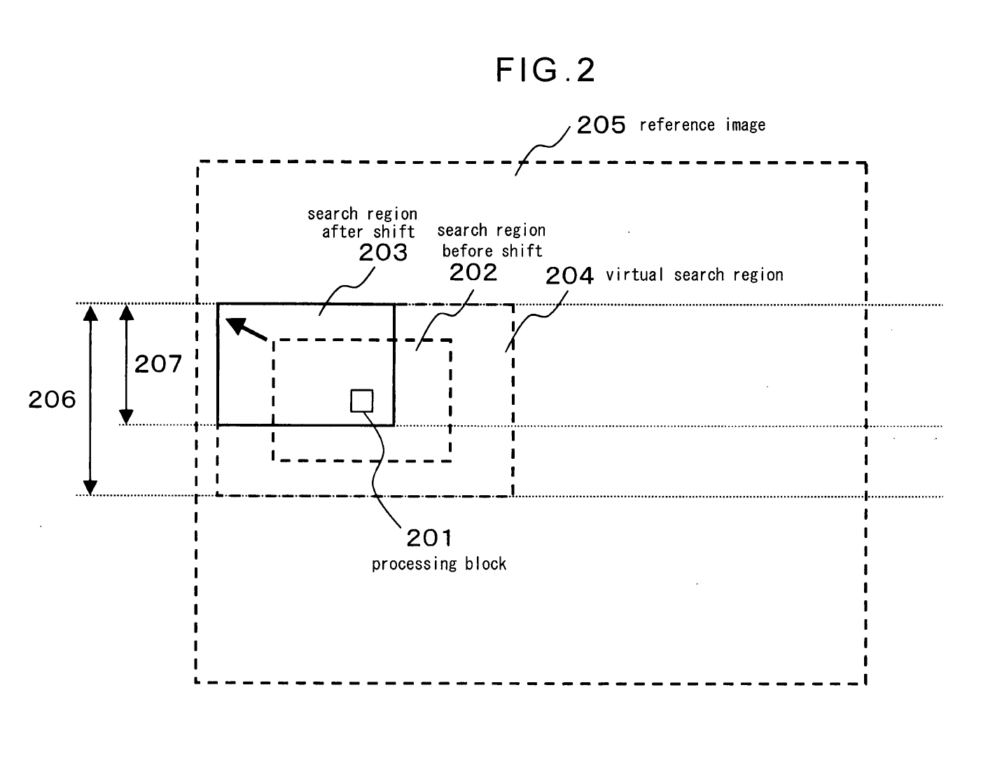

FIG. 2 shows how the search region is moved. Referring to reference numerals in the drawing, 201 denotes a processing block, 202 denotes a search region in the case of no movement, 203 denotes a post-movement search region (second region) in the case of moving the search region, 204 denotes a virtual search region, 205 denotes a reference image, 206 denotes a reference width of the virtual search region (dimension in the vertical direction of the screen), and 207 denotes a reference width (dimension in the vertical direction of the screen) in the case of moving the search region. The search region 202 also denotes a search region (first region) prior to the movement in the case of moving the search region.

The search region determining unit 105 moves the non-movement search region 202 based on the information of the general vector and determines the search region 203 for which the detection of the motion vector is actually implemented. The search region determining unit 105 further moves the search region in compliance with a direction of the general vector of the image. Thereby, a maximum region in which the search can be implemented results in a very broad region shown as the virtual search region 204 in the drawing. As a result, the high-speed panned image can be followed, which the motion vector to be detected with an improved efficiency.

When the search region is moved, the search region 203 on the entire screen is moved in a constant direction. At that time, the search region determining unit 105 specifies the arrangement of the search region 203 so that the arranged search region 203 is inclined area-wise in the direction indicated by the general vector. Therefore, when the detection of the motion vector is continuously implemented to the processing blocks in the horizontal direction, the search region is also continuous while being moved. Accordingly, it becomes necessary to read the reference image data within the reference width (dimension in the vertical direction of the screen) 206 in the vertical direction from the reference image memory 101 in order to actually detect the motion vector with respect to the virtual search region 204. The reference width 206 in the foregoing case is an entire width of the virtual search region 204 in the vertical direction.

In contrast to that, when the detection of the motion vector is implemented to the moved search region 203, the reference image data equivalent to the reference width 207 is only required to be read from the reference image memory 101. The reference width 207 in the foregoing case is not the entire width of the virtual search region 204 in the vertical direction but an entire width of the post-movement search region 203 in the vertical direction, which is narrower than that.

Thereby, not only the processing quantity is simply restricted, but also a reading volume of the memory can be controlled, which largely decreases the power consumption required for the search process.

Because the search region determining unit 105 moves the search region by means of the general vector, a reliability in detecting the general vector is an important factor. The reliability can be determined from the correlativity obtained by the general vector detecting unit 104. More specifically, the correlativity between the two images is low at the position of the general vector, the reliability of the general vector can be judged to be low, while the reliability can be judged to be high when the correlativity is high.

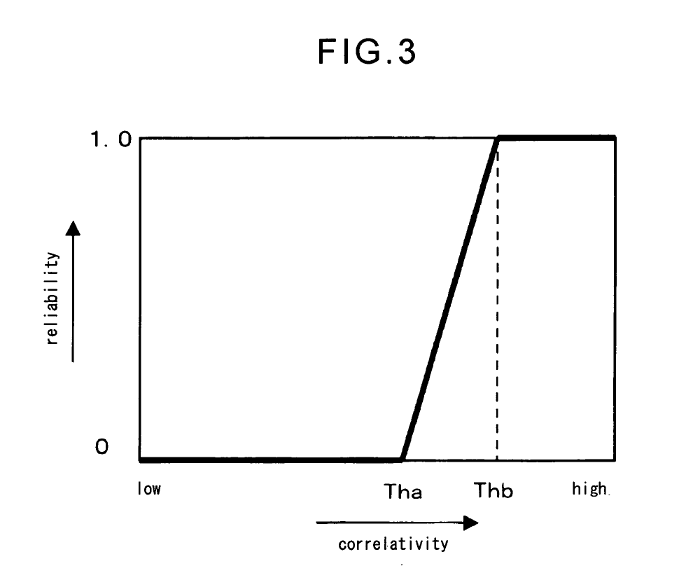

FIG. 3 shows a conversion example of the reliability of the general vector using the correlativity. In the example shown in FIG. 3, two different threshold values Tha and Thb are provided. The reliability is converted to 0.0 based on the judgment as unreliable when the correlativity is equal to or below the threshold value Tha, while the reliability is converted to 1.0 based on the judgment as reliable when the correlativity is equal to or more than the threshold value Thb. Then, the reliability is converted so as to monotonously increase linearly from 0.0 to 1.0 between the threshold values Tha and Thb.

When the general vector is multiplied by the reliability obtained as described, the general vector is corrected in the following manner. When the reliability is high, the general vector is directly adopted, while the general vector is corrected so as to approximate to zero when the reliability is low. Accordingly, the periphery of the processing blocks can be evenly searched. Further, when the search region is moved, the region can be shifted only when the motion is assured.

The method of calculating the correction value of the reliability is not limited to the example shown in FIG. 3. As other possible methods, the conversion may be implemented based on the correlativity by means of a polynominal expression, or the conversion may be implemented by means of a table in which multi-stage threshold values are provided.

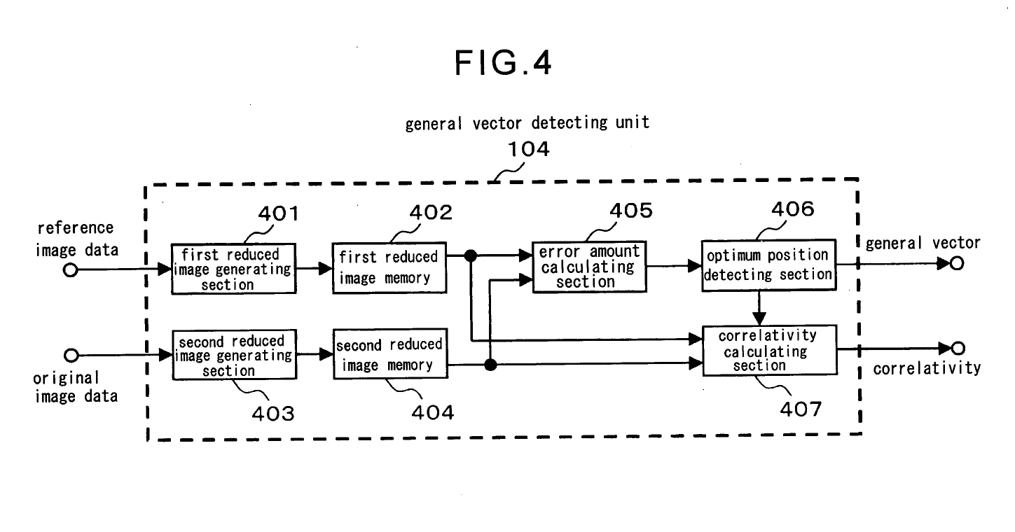

Next, FIG. 4 shows a specific embodiment of the general vector detecting unit 104. Referring to reference numerals in the drawing, 401 denotes a first reduced image generating section, 402 denotes a first reduced image memory, 403 denotes a second reduced image generating section, 404 denotes a second reduced image memory, 405 denotes an error amount calculating section, 406 denotes an optimum position detecting section and 407 denotes a correlativity calculating section. The first reduced image generating section 401 executes a reducing process to the reference image data and then stores the reduced image data in the first reduced image memory 402. The second reduced image generating section 403 executes the reducing process to the original image data and then stores the reduced image data in the second reduced image memory 404.

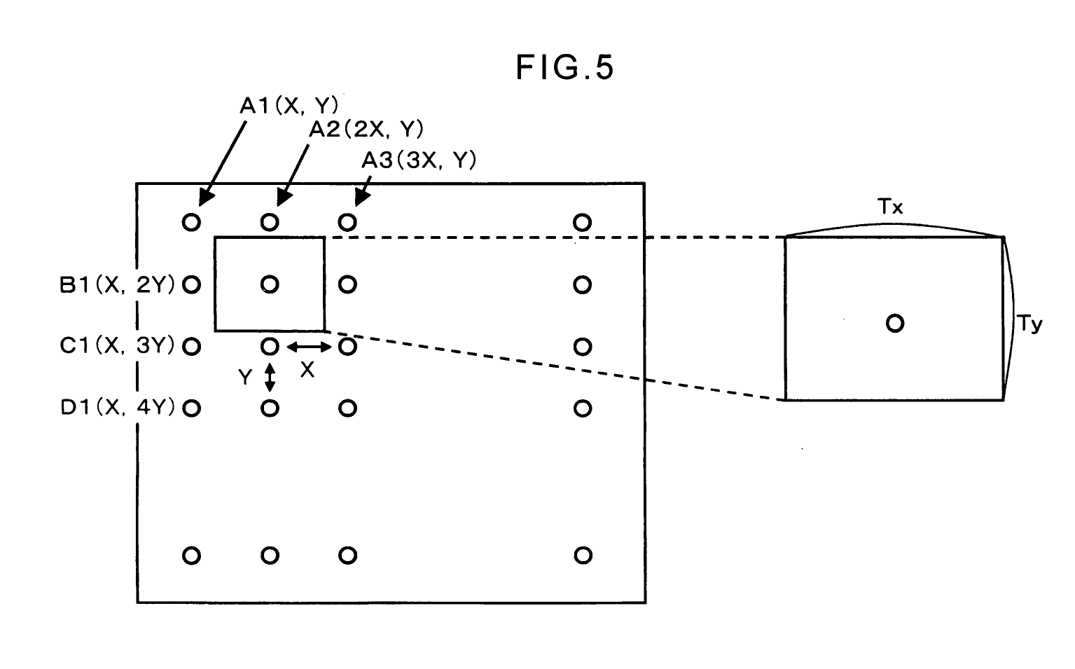

FIG. 5 shows an image reduced by the first reduced image generating section 401 and the second reduced image generating section 403. In the drawing, X denotes an interval of pixels between representative points in the horizontal direction, and Y denotes an interval of pixels between the representative points in the vertical direction. Hereinafter, the interval of the pixels (X, Y) between the representative points is referred to as a representative point interval (X, Y).

The representative point is generated as follows. First, the representative point interval (X, Y) is set, and regions having vertical and horizontal dimensions larger than the set representative point interval (X, Y) are set. More specifically, providing that the horizontal width of the set region is Tx, and the vertical width is Ty as shown in FIG. 5, the respective regions are set so as to satisfy:
Tx>X
Ty>Y

Then, the adjacent regions of the respective regions are disposed so that respective parts of them overlap with each other by a width of [(Tx−X)/2, (Ty−Y)/2]. After the respective regions are set, the representative points are respectively generated based on the image data of the adjacent region.

In the case in which the overlapping region is not provided in generating the representative points, the variation of a panning speed at the time of photographing (moving amount when the entire image moves on the screen in accordance with the panning process) generates the following detection status. In the state in which the panning speed corresponds to an integral multiple of the representative point interval (X, Y), the general vector can be detected with a high precision. However, when the panning speed (moving amount of the entire image) is shifted with respect to the integral multiple (nX, nY: n is an integer) of the representative point interval (X, Y) by ½ of the representative point interval, that is approximately (X/2, Y/2), the generated reduced images are respectively different, which may falsely detects the general vector.

The correlativity also includes the foregoing phenomenon, and the correlativity thereby largely varies depending on a relationship between the panning speed and the representative point interval (X, Y). The variation of the error amount and the correlativity may result in the false detection of the general vector, and a false judgment may be ultimately made to the process of limiting the size of the region for which the motion vector is detected.

On the contrary, when the overlapping region is provided, the generation of the false detection due to any subtle shift of the image equal to or below the representative point interval can be controlled by a filtering effect, and the general vector can be detected across a broad region by increasing a reducing rate of the reduced image while decreasing the number of operations for the error amount. To describe the filtering effect, it is such an effect that the omission of the image information can be controlled when all of the original image data is reflected on any of the representative points in comparison to a simple thinning process which generates the state where the original image data is not entirely reflected on the representative points.

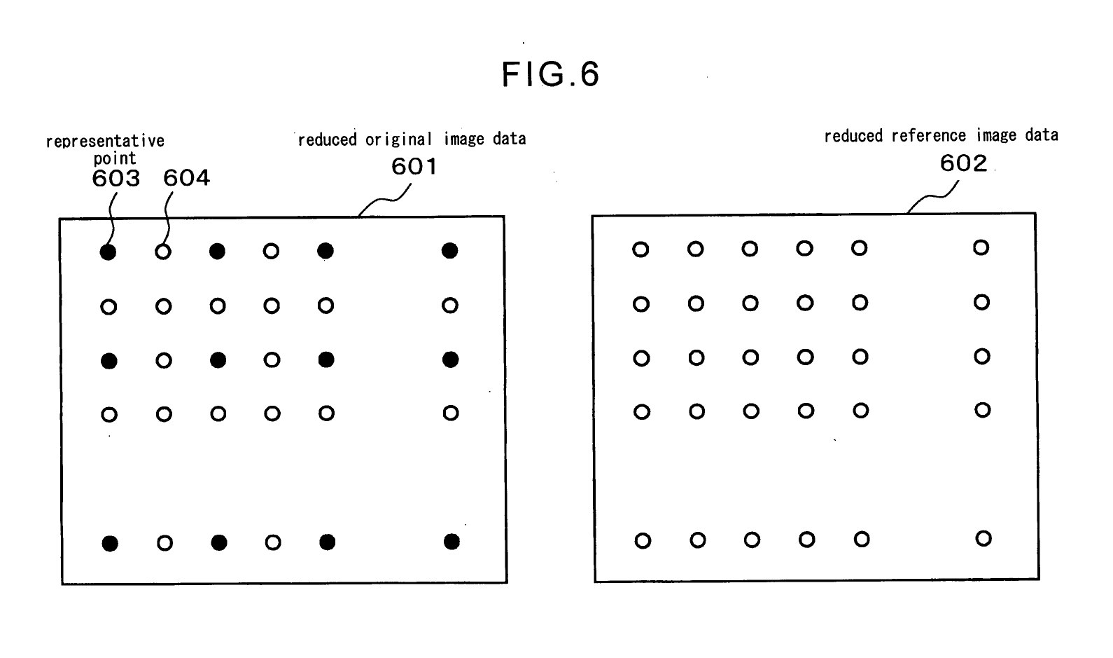

Further, when a width of the overlapping region (overlapping width) present between the adjacent regions is extended to approximately a half of the width (X, Y) of each region (X/2, Y/2), a representative point denoted 603 by a black circle resulting from further thinning the representative point of a reduced original image data 601 shown in FIG. 6 correctly reflects the information of the entire pixel data of the original image. Therefore, when the error amount is operated only based on the data corresponding to the representative point 603 denoted by the black circle, the deterioration of the operating precision can be limited to a small level.

As described, even when the image data is thinned at the representative point to decrease the operation quantity to approximately 1/4, the representative point interval (X, Y) on the reduced reference image data can be maintained, and the general vector can be searched as accurately as in the case of the representative point interval (X, Y) before the thinning.

It is necessary to obtain the representative point based on the representative point interval (X, Y) with respect to the reduced reference image data 602, while only the data of the black-circle representative point 603 after the thinning may be calculated and stored in the second reduced image memory 404 with respect to the reduced original image data 601.

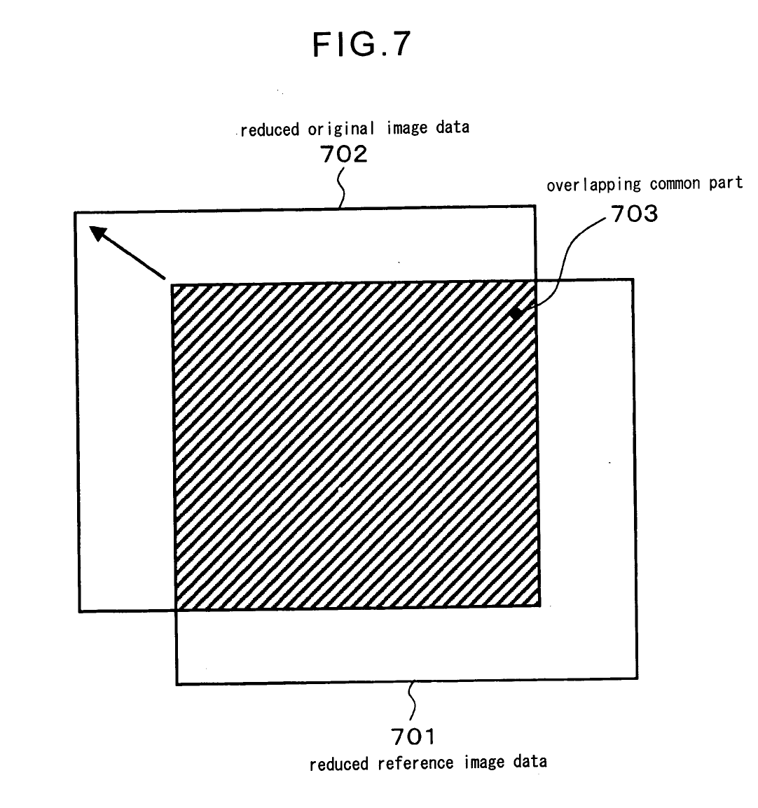

A process executed by the error amount calculating section 405 is described referring to FIG. 7. First, reduced reference image data 701 is read from the first reduced image memory 402, and reduced original image data 702 is read from the second reduced image memory 404. Then, the reduced reference image data 701 and the reduced original image data 702 are overlapped and shifted relative to each other as shown in FIG. 7. An error amount between the two images is obtained from an error amount of representative-point data in an overlapping common part 703. It is necessary to normalize the error amount because the number of pixels in the common part is variable depending on an amount of the shift. An example of the normalization is division by the number of the representative-point data in the common part 703. When the number of the representative-point data in the common part 703 can be patternized, the normalization is also possible by way of multiplication using a parameterized coefficient. Referring to a method of calculating the error amount, any indicator capable of relatively comparing the coincidence level between the images can be used. Examples of the usable indicator include generally known indicators of different types such as sum of differential absolute value, sum of differential square value and a correlation coefficient.

The optimum position detecting section 406 detects the shift amount of the minimum error amount, and the general vector is calculated from the information of the thinning interval at the representative point based on the detected shift amount. The correlativity calculating section 407 obtains the correlativity between the two images when the image data are disposed being shifted relative to each other at a position where the error amount between the reduced reference image data and the reduced original image data is minimized. In the correlativity, any of the different indicators such as sum of differential absolute value, sum of differential square value and correlation coefficient can be used in the same manner as in the case of the error amount.

Below is described a method of calculating the correlativity between the two images is described referring to an example in which the correlation coefficient is used.

The respective numbers of the representative-point data in the common part 703 shown in FIG. 7 in the horizontal direction and in the vertical direction are hypothetically N and M. The pixel data of the reduced reference image data when the pixel at the upper-left end of the common part 703 is denoted by coordinates [0],[0] is R[i][j], the pixel data of the reduced original image data is T[i][j], an average value of the pixel data in the common part of the reduced reference image data is AveR, and an average value of the pixel data in the common part of the reduced original image data is AveT. Srr which is a dispersion of the reduced reference image data, Stt which is a dispersion of the reduced original image data Stt, Str which is a common dispersion of the reduced reference image data and the reduced original image data in the common part, and the correlation coefficient are calculated by means of an operation represented by a numerical expression 1.
[Numerical Expression 1]

$$\begin{matrix}correlation \\ coeficient\end{matrix} = \frac{Str}{\sqrt{Str \times Stt}}$$

$$Str = {\sum }_{i = 0}^{N - 1} {\sum }_{j = 0}^{M - 1} ( R [ i ] [ j ] - AveR ) ( T [ i ] [ j ] - AveT ) / ( N * M )$$

$$Srr = {\sum }_{i = 0}^{N - 1} {\sum }_{j = 0}^{M - 1} ( R [ i ] [ j ] - AveR ) ( R [ i ] [ j ] - AveR ) / ( N * M )$$

$$Stt = {\sum }_{i = 0}^{N - 1} {\sum }_{j = 0}^{M - 1} ( T [ i ] [ j ] - AveT ) ( T [ i ] [ j ] - AveT ) / ( N * M )$$

The correlation coefficient takes values of −0.1 to 1.0, which shows, in general, a higher correlativity between the two image data as it approaches 1.0, a higher reverse correlativity as it approaches −1.0, and there is no correlativity when it is close to zero.

A root operation is executed in the numerical expression 1. Because the root operation results in a complicated process, the formula can be replaced by an approximation formula. When the correlation coefficient shows the negative value, it literally means that there is no correlativity in terms of the detection of the motion vector. Therefore, as an alternatively possible constitution, the correlativity may be set to zero when a numerator of the correlation coefficient is negative as shown in the numerical expression 2 when used as the correlativity, and a square numeral value of the correlation coefficient, that is a numeral value not requiring the root operation may be used for the process thereafter when not used as the correlativity.

[Numerical Expression 2]

if (Str<0)
correlativity=0
else
correlativity=Str×Str/(Srr×St)

According to the present embodiment, the general vector and the correlativity obtained in the general vector detecting unit 104 are used for determining the search region of the motion vector implemented by the vector detecting unit 103. In the process of correcting any blur generated by the hand movement or the like, which is implemented by a video camera, the general vector having a high precision is occasionally demanded. The constitutions of the operations of the general vector and the correlativity can be applied to a preprocess in such a case (correcting the blur generated by the hand movement or the like). The effect that the operation quantity can be decreased is also exerted in the application.

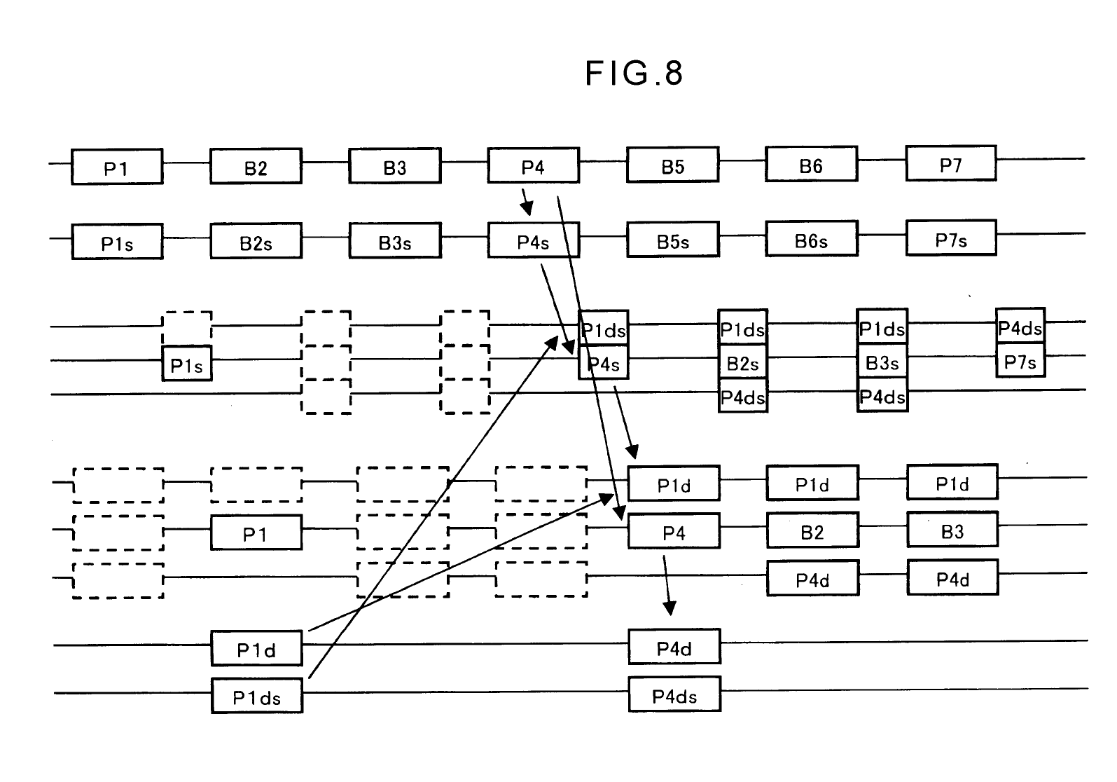

Next, an image process such as generation of the reduced image of the reference image data and the reduced image of the original image data is described referring to FIG. 8.

FIG. 8 shows an example of a timing by which the image process, such as the generation of the reduced image of the reference image data and the reduced image of the original image data, is implemented. In FIG. 8, an P picture in which the motion predicted in a forward direction and a B picture in which the motion is predicted in a reverse direction are shown.

In FIG. 8, reference symbols P1, B2, B3, P4, B5, B6 and P7 denote the image data inputted to the motion vector detecting unit 104. These image data are stored in the original image memory 102 and also inputted to the second reduced image generating section 403 of the general vector detecting unit 104. These image data, P1, B2, B3, P4, B5, B6 and P7, are reduced to reduced image data P1s, B2s, B3s, P4s, B5s, B6s and P7s in the second reduced image generating section 403, and stored in the second reduced image memory 404.

The image data P1 and P4 are encoded and decoded by an encoder and a decoder not shown. In FIG. 8, P1d and P4d are reference image generated through implementing the encoding and decoding processes to the image data P1 and P4. The reference image data P1d and P4d are stored in the reference image memory 101 and also inputted to the first reduced image generating section 401. Reference image data P1d an P4d are reduced in the first reduced image generating section 401 and stored in the first reduced image memory 402.

A process of detecting the motion vector of the image data P4 is described, First, prior to the commencement of the motion vector detection, the general vector and the correlativity are calculated by means of the reduced reference image data P1ds and the reduced original image data P4s in the general vector detecting unit 104. In the search region determining unit 105, the search region is determined by means of the calculated general vector and the correlativity. In the vector detecting unit 103, the reference image P1d is read from the reference image memory 101 and the image data P4 is read from the original image memory 102. Further, in the vector detecting unit 103, the foregoing operation process is implemented to the reference image P1d and the image data P4 in the search region set by the search region determining unit 105 so that the motion vectors of the processing blocks are detected.

The image data P4 is encoded and decoded by the encoder and the decoder not shown and converted into the reference image data P4d again. The reference image data P4d to be reconverted is stored in the reference image memory 101 and reduced by the first reduced image generating section 401 of the general vector detecting unit 104 to be thereby converted into the reduced reference image memory P4ds. The reduced reference image data P4ds to be reconverted is stored in the first reduced image memory 402.

When the vector detection is carried out to the image data B2, the general vector and the correlativity are calculated by means of the reduced reference image data P1ds and B2s for a forward part on a time axis. The general vector and the correlativity are calculated by means of the reduced reference image data P4ds and B2s for a rear part of on the time axis.

In the search region determining unit 105, the search region is determined for the forward and the rear parts based on the calculated general vector and the correlativity. In the vector detecting unit 103, the reference image P1d and P4d are read from the reference image memory 101, and the image data B2 is read from the original image memory 102. After that, in the vector detecting unit 103, the motion vector is detected in the search region set by the search region determining unit 105. The image data B2, which is not used as the reference image, is encoded by the encoder not shown, however, is not subjected to the decoding process.

In an I picture, which does not require the reference image, the general vector and the motion vector are not detected, because of which the I picture is not shown in FIG. 8. However, the I picture is used as the reference image. Accordingly, the I picture is encoded by the encoder not shown and decoded by the decoder. The I picture is then stored in the reference image memory 101 as the reference image data, and further, reduced by the first reduced image generating section 401 and stored in the first reduced image memory 402.

The detection of the motion vector can be implemented by repeating the foregoing processes.

As described, according to the present embodiment, the general vector and the correlativity are always calculated based on the information of the very image used by the general vector detecting unit 104 for the detection before the detection of the motion vector by the vector detecting unit 103, and then, the search region determining unit 105 determines the search region based on the calculated information. According to the constitution, even when the rapid change occurs in the video, the search region accurately reflecting the motion generated in the image can be set. Further, not only the region is simply moved in the direction of the general vector, but also the reliability of the general vector is calculated based on the correlativity so that the search region of a suitable size can be provided at a suitable position. Therefore, the search region can be virtually extended and the precision accuracy in the detection of the motion vector can be increased while the cutbacks of the circuit size, processing quantity and power consumption are being realized.

### Embodiment 2

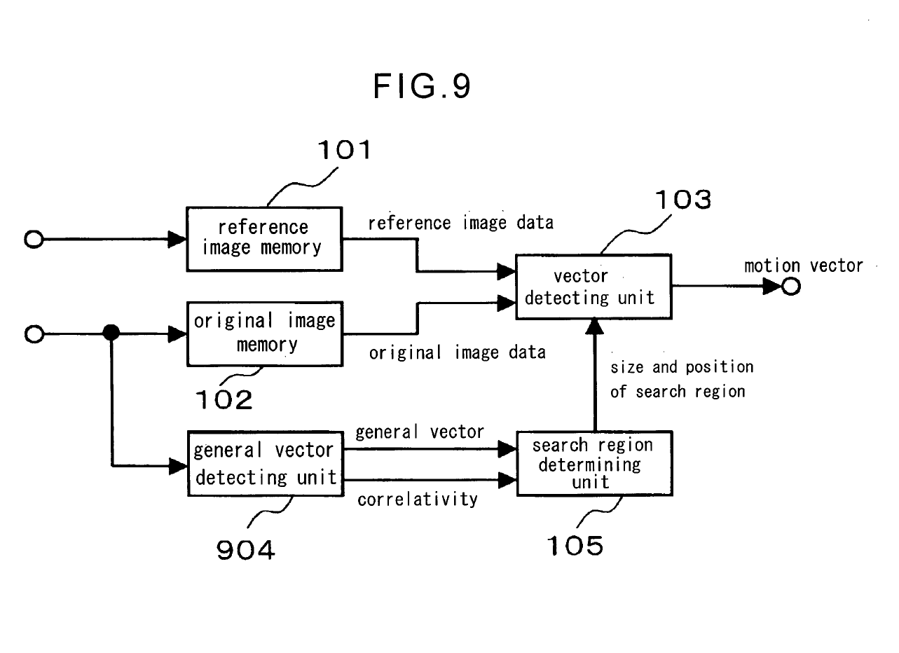

FIG. 9 shows a block diagram of a motion vector detecting device according to an embodiment 2 of the present invention.

Referring to reference numerals in FIG. 9, 101 denotes a reference image memory, 102 denotes an original image memory, 103 denotes a vector detecting unit, 904 denotes a general vector detecting unit, and 105 denotes a search region determining unit. The present embodiment is different to the embodiment 1 in that the general vector detecting unit 904 does not use the reference image data as the input data.

In the embodiment 1, the reduced reference image data is generated from the actual reference image data encoded and decoded, in contrast to which the reduced reference image data is generated from the original image data which is the pre-encoding reference image data in the present embodiment.

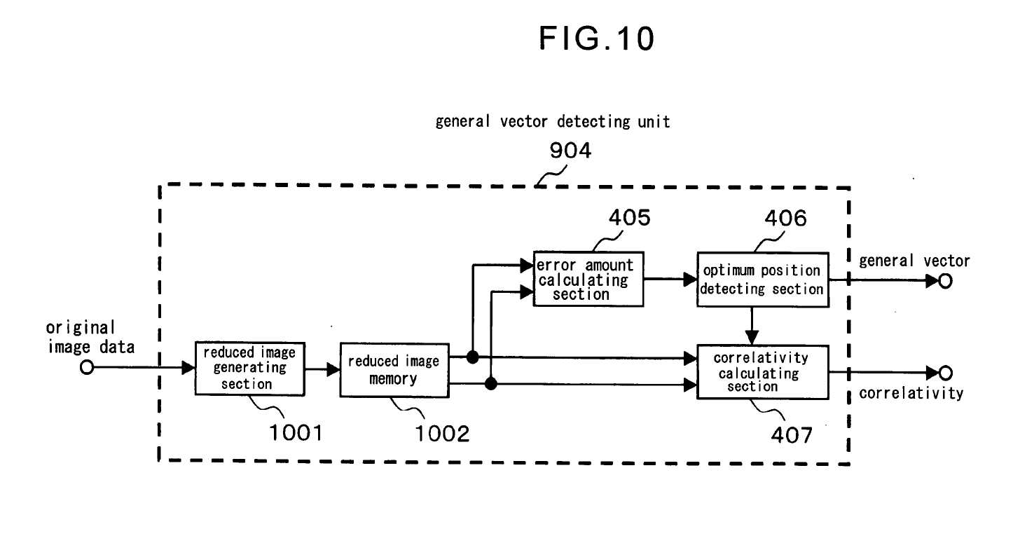

A specific embodiment of the general vector generating unit 904 is shown in FIG. 10. Referring to reference numerals in FIG. 10, 1001 denotes a reduced image generating section, 1002 denotes a reduced image memory, 405 denotes an error amount calculating section, 406 denotes an optimum position detecting section, and 407 denotes a correlativity calculating section. The general vector detecting unit 904 is necessarily adapted to reduce the image, however, only the reduced image generating section 1001 for reducing the original image data is provided as a component serving to reduce the image. The reduced image data outputted from the reduced image generating section 1001 is stored in the reduced image memory 1002.

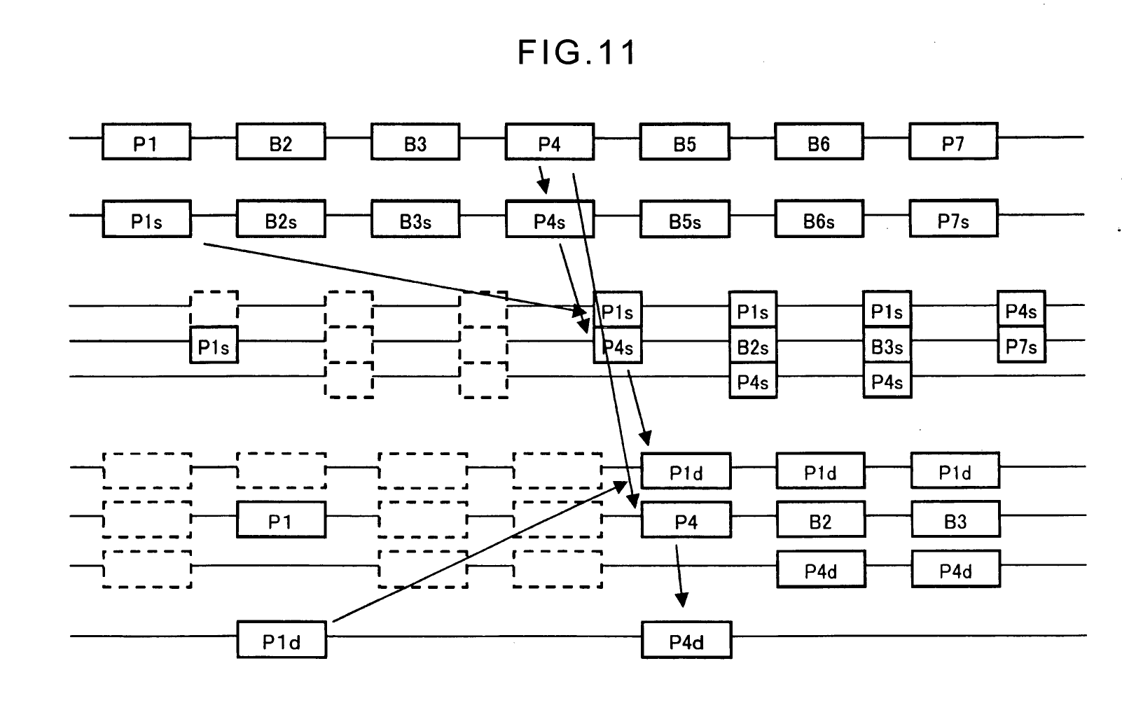

FIG. 11 shows an example of a timing by which the image process is implemented. In FIG. 11, P1, B2, B3, P4, B5, B6 and P7 denote the image data to be inputted. These image data are stored in the original image memory 102 and inputted to the reduced image generating section 1001 of the general vector detecting unit 904. These image data, P1, B2, B3, P4, B5, B6 and P7, are reduced by the reduced image generating section 1001 and thereby converted into reduced image data P1s, B2s, B3s, P4s, B5s, B6s and P7s, and stored in the reduced image memory 1002.

P1d and P4d are reference image data generated by encoding and decoding the image data P1 and P4 using the encoder and the decoder not shown and stored in the reference image memory 101.

A process of detecting the motion vector in the image data P4 is described. The following process is implemented prior to the commencement of the motion vector detection. First, in the general vector detecting unit 904, the general vector and the correlativity are calculated by means of reduced original image data P1s resulting from reducing the original image data P1 which is the pre-encoding reference image data P1d and the reduced original image data P4s currently targeted for the motion vector detection. In the search region determining unit 105, the search region is determined by means of the calculated general vector and the correlativity. The present embodiment is different to the embodiment 1 only in the method of generating the reduced original image data P1s. Therefore, the general vector and the correlativity can be calculated in the same manner as described in the embodiment 1.

In the vector detecting unit 103, the reference image data P1d is read from the reference image memory 101, and the image data P4 is read from the original image memory 102. Further, in the vector detecting unit 103, the motion vector is detected in the search region set by the search region determining unit 105 as a result of implementing the operation process previously described to the reference image data P1d and the image data P4.

The image data P4 is encoded and decoded by the encoder and the decoder not shown and thereby converted into the reference image data P4d again. The reference image data P4d to be reconverted is stored in the reference image memory 101.

When the detection of the motion vector is carried out to the image data B2, the general vector and the correlativity are calculated by means of the reduced reference image data P1s and B2s for the forward part on the time axis. The general vector and the correlativity are calculated by means of the reduced reference image data P4s and B2s for the rear part on the time axis. Any process there after is the same as described in the embodiment 1.

Thus, the general vector and the correlativity can be calculated by means of the reduced image data of the original image data as a basis of the reference image data, which eliminates the generation of the reduced reference image data directly from the reference image data.

In the case of using the black-circle representative point 603 resulting from further thinning the representative point shown in FIG. 6 to calculate the error amount and the correlativity, in the same manner as described in the embodiment 1, it is unnecessary to calculate a representative point 604 denoted by an open circle with respect to the reduced original image data of the B picture which is not used as the reference image.

According to the present embodiment, it is unnecessary to provide the reduced image generating section and the reduced image memory exclusively used for the reference image, which further contributes to the decrease of the operation quantity and the circuit size.

As thus far described, the motion vector detecting device according to the present invention, wherein the search region of a suitable size is provided in a suitable position based on the image data actually used for the vector detection, is advantageous as a technology for prediction/encoding and the like which requires the curtailments of the circuit size, processing quantity and power consumption.

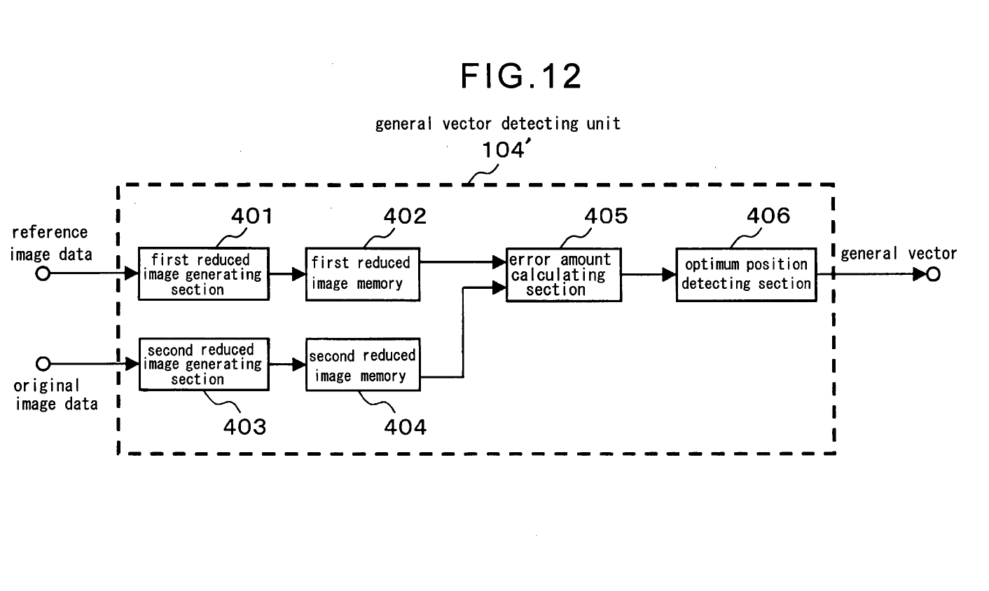

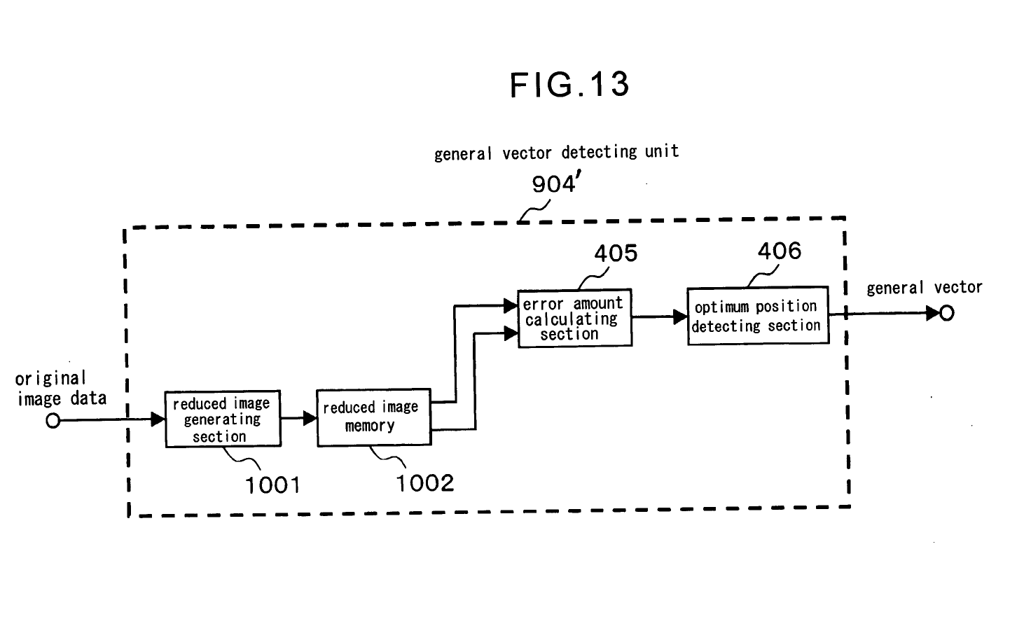

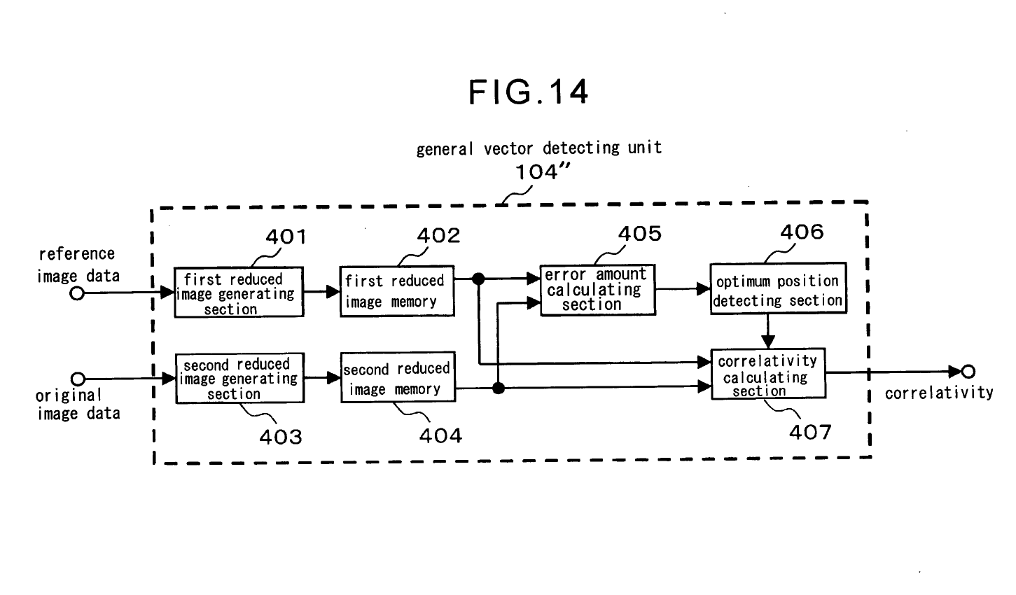

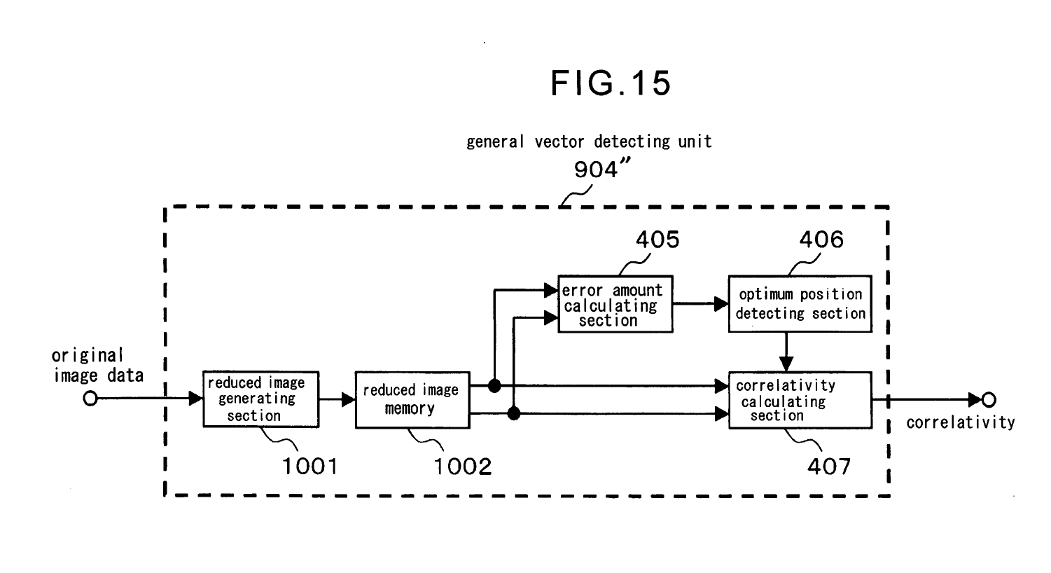

The general vector detecting units 104 and 904 recited in the embodiments 1 and 2 respectively include the correlativity calculating section 407. However, the correlativity calculating section 407 may be provided outside the general vector detecting units 104 and 904. Further, as shown in general vector detecting units 104′ and 904′ of FIGS. 12 and 13, the general vector detecting unit may not necessarily include the correlativity calculating section 407, in which case an effect similar to that of the embodiments 1 and 2 can be exerted. Further, as shown in general vector detecting units 104″ and 904″ of FIGS. 14 and 15, the general vector detecting unit may be adapted to output only the correlativity without outputting the general vector so that the general vector detecting unit functions as a correlativity detecting unit, in which case an effect similar to that of the embodiments 1 and 2 can be exerted.

While there has been described what is at present considered to be preferred embodiments of this invention, it will be understood that various modifications may be made therein, and it is intended to cover in the appended claims all such modifications as fall within the true spirit and scope of this invention.

1. A motion vector detecting device, wherein original image data constituting a video unit of digital video data is divided into a plurality of processing blocks and the respective processing blocks are subjected to a block-matching process relative to reference image data temporally close to the original image data so that motion vectors of the processing blocks are detected, comprising:
a general vector detecting unit for detecting a general vector serving as a shift amount of the original image data relative to the reference image data on an entire screen;
a search region determining unit for designating a region on the original image data including the processing block to be block-matched and biasing area-wise in a direction indicated by the general vector as a search region of the motion vector; and
a vector detecting unit for executing the block-matching process to the search region and thereby detecting the motion vector of the processing block to be processed.

2. A motion vector detecting device as claimed in claim 1, wherein
the search region determining unit sets a first region including the processing block to be processed and designates a second region which is the first region position-shifted in the direction indicated by the general vector as the search region of the motion vector.

3. A motion vector detecting device as claimed in claim 2, wherein
the general vector detecting unit restricts an amount of the position shift of the second region relative to the first region so as to be in a range of the second region in which the processing block is included.

4. A motion vector detecting device as claimed in claim 1, wherein
the general vector detecting unit comprises:
an error amount detecting section for obtaining an error amount between pixel data in a part where the original image data and the reference image data are overlapped with each other while the two data are being shifted relative to each other; and
an optimum position detecting section for detecting the general vector based on the shift amount by which the error amount can be minimized.

5. A motion vector detecting device as claimed in claim 4, wherein
the error amount detecting section obtains the error amount between a representative point at which the original image data is thinned and a representative point at which the reference image data is thinned.

6. A motion vector detecting device as claimed in claim 5, wherein
the error amount detecting section averages pixels present in a region having a width wider than an interval between the adjacent representative points when the representative points are obtained by thinning the original image data and the reference image data.

7. A motion vector detecting device as claimed in claim 5, wherein
the error amount detecting section sets an interval of the pixels at which the original image data is thinned relative to an interval of the pixels at which the reference image data is thinned to N times (N is an integer) when the representative points are obtained by thinning the original image data and the reference image data and obtains the error amount only based on the data of the representative point at which the original image data is thinned.

8. A motion vector detecting device, wherein original image data constituting a video unit of digital video data is divided into a plurality of processing blocks and the respective processing blocks are subjected to a block-matching process relative to reference image data temporally close to the original image data so that motion vectors of the processing blocks are detected, comprising:
a correlativity calculating section for detecting a correlativity between the original image data and the reference image data;
a search region determining unit for designating a search region of the motion vector including the processing block to be block-matched and narrowing the search region in the case of the high correlativity in comparison to the search region in the case of the low correlativity; and
a vector detecting unit for executing the block-matching to the search region and thereby detecting the motion vectors of the respective processing blocks.

9. A motion vector detecting device as claimed in claim 8, wherein
the correlativity calculating section obtains the correlativity between a representative point at which the original image data is thinned and a representative point at which the reference image data is thinned.

10. A motion vector detecting device as claimed in claim 9, wherein
the correlativity calculating section averages pixels present in a region having a width wider than an interval between the adjacent representative points when the representative points are obtained by thinning the original image data and the reference image data

11. A motion vector detecting device, wherein original image data constituting a video unit of digital video data is divided into a plurality of processing blocks and the respective processing blocks are subjected to a block-matching process relative to reference image data temporally close to the original image data so that motion vectors of the processing blocks are detected, comprising:
a general vector detecting unit for detecting a general vector serving as a shift amount of the original image data relative to the reference image data on an entire screen and calculating a correlativity in disposing the reference image data and the original image data being shifted relative to each other by the shift amount when the general vector is determined;
a search region determining unit for specifying a size and a position of a search region of the motion vector based on the general vector and the correlativity; and
a vector detecting unit for executing the block-matching process to the search region and thereby detecting the motion vectors of the respective processing blocks.

12. A motion vector detecting device as claimed in claim 11, wherein
the search region determining unit sets a first region including the processing block to be block-matched and designates a second region which is the first region position-shifted as the search region of the motion vector, and further, restricts an amount of the position shift of the second region relative to the first region to a minimum level when the correlativity is high and the general vector is small.

13. A motion vector detecting device as claimed in claim 11, wherein
the search region determining unit restricts an extent by which the general vector is reflected on the shift amount when the correlativity is equal to or less than a predetermined threshold value.

14. A motion vector detecting device as claimed in claim 11, wherein general vector detecting unit comprises:
an error amount detecting section for obtaining an error amount between pixel data in a part where the original image data and the reference image data are overlapped with each other while the two data are being shifted relative to each other;
an optimum position detecting section for detecting the general vector based on the shift amount by which the error amount can be minimized; and
a correlativity calculating section for calculating a correlativity between the pixel data in the overlapping part.

15. A motion vector detecting device as claimed in claim 14, wherein
the error amount detecting section and the correlativity calculating section obtain the error amount and the correlativity between a representative point at which the original image data is thinned and a representative point at which the reference image data is thinned.

16. A motion vector detecting device as claimed in claim 15, wherein
the error amount detecting section and the correlativity calculating section average pixels present in a region having a width wider than an interval between the adjacent representative points when the representative points are obtained by thinning the original image data and the reference image data.

17. A motion vector detecting device as claimed in claim 15, wherein
the error amount detecting section and the correlativity calculating section sets an interval of the pixels at which the original image data is thinned relative to an interval of the pixels at which the reference image data is thinned to N times (N is an integer) when the representative points are obtained by thinning the original image data and the reference image data and obtain the error amount and the correlativity only based on the data of the representative point at which the original image data is thinned.

18. A motion vector detecting method, wherein original image data constituting a video unit of digital video data is divided into a plurality of processing blocks and the respective processing blocks are subjected to a block-matching process relative to reference image data temporally close to the original image data so that motion vectors of the processing blocks are detected, comprising:
a general vector detecting step for detecting a general vector serving as a shift amount of the original image data relative to the reference image data on an entire screen;
a search region determining step for designating a region on the original image data including the processing block to be block-matched and biasing area-wise in a direction indicated by the general vector as a search region of the motion vector; and
a vector detecting step for executing the block-matching process to the search region and thereby detecting the motion vector of the processing block to be processed.

19. A motion vector detecting method as claimed in claim 18, wherein
a first region including the processing block to be processed is set and a second region which is the first region position-shifted in the direction indicated by the general vector is designated as the search region of the motion vector in the search region determining step.

20. A motion vector detecting method as claimed in claim 19, wherein the general vector detecting step comprises:
an error amount detecting step for obtaining an error amount between pixel data in a part where the original image data and the reference image data are overlapped with each other while the two data are being shifted relative to each other; and
an optimum position detecting step for detecting the general vector based on the amount of the position shift by which the error amount can be minimized.

21. A motion vector detecting method, wherein original image data constituting a video unit of digital video data is divided into a plurality of processing blocks and the respective processing blocks are subjected to a block-matching process relative to reference image data temporally close to the original image data so that motion vectors of the processing blocks are detected, comprising:
a correlativity calculating step for detecting a correlativity between the original image data and the reference image data;
a search region determining step for designating a search region of the motion vector including the processing block to be block-matched and narrowing the search region in the case of the high correlativity in comparison to the search region in the case of the low correlativity; and
a vector detecting step for executing the block-matching to the search region and thereby detecting the motion vectors of the respective processing blocks.

22. A motion vector detecting method as claimed in claim 21, wherein
the correlativity is obtained between a representative point at which the original image data is thinned and a representative point at which the reference image data is thinned in the correlativity calculating step.

23. A motion vector detecting method, wherein original image data constituting a video unit of digital video data is divided into a plurality of processing blocks and the respective processing blocks are subjected to a block-matching process relative to reference image data temporally close to the original image data so that motion vectors of the processing blocks are detected, comprising:
a general vector detecting step for detecting a general vector serving as a shift amount of the original image data relative to the reference image data on an entire screen and calculating a correlativity in disposing the reference image data and the original image data being shifted relative to each other by the shift amount when the general vector is determined;
a search region determining step for specifying a size and a position of a search region of the motion vector based on the general vector and the correlativity; and
a vector detecting step for executing the block-matching process to the search region and thereby detecting the motion vectors of the respective processing blocks.

24. A motion vector detecting method as claimed in claim 23, wherein
a first region including the processing block to be block-matched is set and a second region which is the first region position-shifted is designated as the search region of the motion vector, and further, an amount of the position shift of the second region relative to the first region is restricted to a minimum level when the correlativity is high and the general vector is small in the search region determining step.

25. A motion vector detecting method as claimed in claim 23, wherein
an extent by which the general vector is reflected on the shift amount is restricted when the correlativity is equal to or less than a predetermined threshold value in the search region determining step.

26. A motion vector detecting method as claimed in claim 23, wherein the general vector detecting step comprises:
an error amount detecting step for obtaining an error amount between pixel data in a part where the original image data and the reference image data are overlapped with each other while the two data are being shifted relative to each other;
an optimum position detecting step for detecting the general vector based on the shift amount by which the error amount can be minimized; and
a correlativity calculating step for calculating a correlativity between the pixel data in the overlapping part.
